(19) United States
(12) Patent Application Publication
(10) Pub. No.: US 2018/0014537 A1
(43) Pub. Date: Jan. 18, 2018

(54) NOVEL COMPOSITIONS AND METHODS FOR CONTROLLING SOIL BORNE PATHOGENS OF AGRICULTURAL CROPS

(71) Applicant: ADJUVANTS UNLIMITED LLC, MEMPHIS, TN (US)

(72) Inventors: KEVIN CROSBY, GERMANTOWN, TN (US); MICKEY BRIGANCE, GERMANTOWN, TN (US); JENNIFER JORDAN BEAR, CORDOVA, TN (US); WILLIAM R FOWLKES, COLLIERVILLE, TN (US); SHANA HALL, FAULKNER, MS (US); MARSHAL WIXSON, MEMPHIS, TN (US); BRANDT KNOPP, FAIRFIELD, CA (US)

(73) Assignee: ADJUVANTS UNLIMITED LLC, MEMPHIS, TN (US)

(21) Appl. No.: 15/553,484

(22) PCT Filed: Feb. 29, 2016
(86) PCT No.: PCT/US16/20131

§ 371 Date: Aug. 24, 2017

Related U.S. Application Data
(60) Provisional application No. 62/126,261, filed on Feb. 27, 2015.

(51) Int. Cl. A01N 37/02; A01N 37/10

(52) U.S. Cl. CPC A01N 37/02; A01N 37/10

(57) ABSTRACT

Compositions and methods for controlling pathogens including nematodes fungi oomycetes and bacteria afflicting a broad variety of crop species by application to soil of a non-phytotoxic formulation of a blend of fatty acids disclosed. The fatty acid compostions are prepared as emulsifiable concentrates and applied directly to the soil or solid growing medium where the plant in need of treatment is growing.

### CROSS-REFERENCE TO RELATED APPLICATIONS

This application claims the benefit of U.S. Provisional Application No. 62/126,261, which was filed Feb. 27, 2015, and is hereby incorporated by reference in its entirety for all that it teaches.

### FIELD OF THE INVENTION

The present invention relates to compositions and methods for controlling pathogens, including nematodes, fungi, oomycetes, and bacteria afflicting a broad variety of crop species by application to soil of a non-phytotoxic formulation of a blend of fatty acids.

### BACKGROUND OF THE INVENTION

Plants, being sessile, cannot evade disease or parasites. A broadly diverse set of defense mechanisms exist to protect plants from pathogen attack, but these can often be overcome by particular pathogens with deleterious effects on plant growth and survival. While this effect is widespread in nature, it is of particular interest when the species are used for agricultural purposes. Farmers and researchers spend significant time and money to protect crops from attack so harvestable economic yield may be obtained. With a continually increasing world population, this is an issue of great societal concern.

Many pathogens can be controlled or managed by applications of synthetic pesticides. While generally effective, there are concerns about the effects of these non-natural chemicals on both the natural eco-system and on the health of farmworkers and consumers. Replacing synthetic pesticides with crop protectants that are naturally derived and inherently less toxic to aquatic and terrestrial ecosystems and to humans is a current topic of considerable research.

One area of chemistry that has been investigated in the past is that of fatty acids and fatty acid derivatives. Before the era of modern synthetic pesticides, research on fatty acids indicated, at first, potential for these compounds to act as plant protectants. However, for a variety of reasons, including phytotoxicity issues at antimicrobial effective amounts, fatty acids were never developed for widespread use in agricultural systems and remain only as an interesting side-line in the overall development of plant protection agents.

An early report of nematocidal activity of the general class of mono- and dicarboxylic acid esters was reported in U.S. Pat. No. 2,852,426 to Stansbury (“Stansbury”). The only monocarboxylic fatty acid claimed by Stansbury as having nematocidal activity is undecylenic acid. Stansbury teaches application to the soil of non-phytotoxic compounds, especially esters of dicarboxylic acids such as sebacic, malonic, maleic, fumaric, and azelaic acids. Numerous formulation examples are given, but only the application of single active compounds is taught.

Fatty acids were reported by Tarjan and Cheo (1956) to have potential as nematode control agents. This report detailed many aspects of the effects of fatty acids on nematodes including: 1) fatty acids could impact more than one species of nematodes, 2) some fatty acid soaps were as effective as the corresponding free acids, 3) emulsifiable concentrates of fatty acids were most effective when a stable emulsion formed, and 4) microemulsions reduced fatty acid activity against nematodes. Single fatty acids were used in all the tests, usually focused on undecylenic acid, an unsaturated C11 fatty acid. However, fatty acids of different chain length were tested, and the most active on free living nematodes were C8, C9, and C10. Both shorter and longer chain fatty acids were reported to be less active. When Heterodera tabacum cysts were soaked in fatty acid solutions then allowed to hatch, C9 was the most effective fatty acid, followed by C8, C10, and C11. However, fatty acids applied to soil in which tomato plants were growing proved to be phytotoxic. When undecylenic acid was applied to turfgrass at a rate of 1-2 g/ft² significant reductions in nematode populations were observed; however, phytotoxicity in the form of discoloration was observed after treatment. Only a single stable emulsion was reported, and most work was done in vitro with only two applications to plants from a horticultural perspective: an application to turf and treatment of lily bulbs. Tarjan and Cheo did not teach fatty acid combinations, mixing fatty acids with other nematicides, applications to perennial trees or shrubs, or applications of such combinations to annual crops such as tomatoes or strawberries. The single stable formulation reported was in fact made by a third party (Mallinckrodt Chemical Works), and no detailed information on additional stable formulations was reported. Methods to reduce or eliminate phytotoxicity to growing plants were not reported.

The problem of phytotoxicity and biological activity (i.e., pesticide activity against non-plants) is a theme in both patent and scientific literature since before the publication by Tarjan and Cheo. Yet, phytotoxicity is so prevalent that it is not always reported in the context of nematicides or other pesticide activities of fatty acids and their derivatives. U.S. Pat. No. 2,622,975 to Zimmerman et al. (“Zimmerman”) claims undecylenic acid (and its esters) as contact herbicides capable of killing at least 17 plant species at use rates of 3.2% or less, and causing severe leaf damage at 1% or less. This explains the observation of Tarjan and Cheo of phytotoxicity when undecylenic acid was applied to turf for nematode control. U.S. Pat. Nos. 3,326,664 and 3,340,040 to Tso (“Tso”), U.S. Pat. No. 3,438,765 to Tso et al. (“Tso et al.”), and U.S. Pat. No. 3,620,712 to Conklin detail the use of fatty acids as plant pruning aids to suppress growth of tobacco lateral shoots (“suckers”). Used at the correct rates, the medium chain fatty acids (preferably C10) can selectively control lateral shoot growth, but, if used incorrectly, can severely damage the tobacco plant. Frick and Burchill (U.S. Pat. No. 3,931,413) found medium chain fatty acids and their salts were strong fungicides for some diseases of apples, but sprays could only be applied when trees were dormant to avoid severe phytotoxicity. Other compositions were specifically formulated to avoid phytotoxicity as in U.S. Pat. No. 5,093,124 to Kulenkampff and U.S. Pat. No. 5,246,716 to Sedun and Kulenkampff.

U.S. Pat. No. 5,284,819 to Zorner et al. claims monoglycol esters of fatty acids as effective non-selective herbicides. U.S. Pat. No. 6,608,003 to Smiley specifically claims the ammonium salt of pelargonic acid as an effective herbicide with rapid non-selective phytotoxicity to plants when applied as an aqueous solution. These claims, in addition to those in Zimmerman et al., show both esters and salts of fatty acids can be highly phytotoxic herbicides.

When fatty acids were applied to plants for nematode control, as previously observed, Tarjan and Cheo observed phytotoxicity. Efforts to remove phytotoxicity while preserving good pesticidal activity have led to multiple reports of fatty acids mixed with other active ingredients or fatty acid derivatives. In U.S. Pat. No. 5,192,546 and U.S. Pat. No. 5,346,698 insecticidal compositions of avermectins and fatty acids were found to effectively control insects without phytotoxicity when the fatty acid component of the blend present is at least 0.2% concentration, although no upper limit is given. It seems, therefore, that fatty acid (sometimes abbreviated herein as “FA”) concentration may be related to phytotoxicity. In U.S. Pat. No. 5,674,897, Kim et al. show that fatty acid esters can be used to control nematodes without phytotoxicity with optimal concentration of the fatty acid ester to be about 0.5% in solution when applied to soil. Fatty acid esters were found to effectively control Caenorhabditis elegans (a nematode not parasitic to plants). In a phytotoxicity screen all fatty acid esters were much less phytotoxic than pelargonic acid, proving the ester modification shows less phytotoxicity than free acids. Interestingly, in this study microemulsion formulations were not less active than standard emulsions in distinct contrast to the results of Tarjan and Cheo. In U.S. Pat. No. 5,698,592, Kim et al. extended their previous findings about fatty acid esters. The most toxic ester was pelargonic acid methyl ester (PAME) which was active against a variety of nematodes including Lance nematode (Hoplolaimus galeatus), root-knot nematode (Meloidogyne javanica) and soybean cyst nematode (Heterodera glycines). When tested for phytotoxicity, PAME was 40 fold less phytotoxic than the parent pelargonic acid, showing the ester modification greatly reduced phytotoxicity. However, as reported by Davis et al. (1997) the apparent selectivity of PAME was narrower than initially thought. Application of 3.2 uL of PAME per liter as a soil drench gave good control of Meloidogyne incognita in greenhouse pot tests, but significant phytotoxicity occurred when concentrations of PAME exceeded 4.8 uL per liter. Thus the “therapeutic window” of PAME is narrow and the possibility of phytotoxicity from an incorrect application exists. An extension of the fatty acid methyl ester development came in U.S. Pat. No. 6,124,359 where Feitelson et al. found that PAME is toxic to eggs of nematodes including those in cysts typically formed by Heterodera or Meloidogyne species. None of these patents show any data from actual field trial applications into native soils, but are limited to greenhouse pot studies only.

Additional derivatives of fatty acids are described in U.S. Pat. No. 6,903,052 where Williams et al. describe a series of reduced phytotoxicity derivatives of fatty acids based on preferred chain lengths of C16-C20 as specific inhibitors of nematode delta-12-fatty acid desaturase enzymes. The need for derivatives is based on the statement that “it may be impossible to completely decouple the phytotoxicity and nematocidal activity of pesticidal fatty acids because of their non-specific mode of action.”

The derivatives of special interest include esters of longer chain fatty acids (ricinoleic acid, ricinelaidic acid, crepenynic acid, and vernolic acid) which are significantly larger than the previously described PAME and much less phytotoxic as shown by differential toxicity against tomato seedlings (e.g., at equivalent concentrations PAME led to 100% mortality of seedling at 24 hours compared to 0% for ricinoleic acid methyl ester). The derivatives described, therefore, appear to have separated nematocidal activity from phytotoxicity.

The answer to the question of whether all fatty acids chain lengths are nematocidal or only specific carbon lengths has proven elusive. A definitive answer as to the most effective carbon chain length is also not found in the literature. Tarjan and Cheo reported that C8, C9, and C10 were the most efficacious chain lengths in short term lab studies, but that undecylenic (C11) was also highly efficacious in a longer term trial involving application to turf.

Sitaramaiah and Singh (1977) found short chain acids (acetic, formic, propionic, and butyric) could either inhibit or promote nematode growth depending on species and conditions, but at high concentrations the acids were phytotoxic. These same acids were examined by Malik and Jairajpuri (1977) who observed nematocidal activity only at high concentrations, in contrast to Sitaramaiah and Singh. Stadler et al. (1994) isolated a nematocidal extract from a Basidiomycete (Hericium coralloides) fermentation broth and isolated a blend of linoleic, oleic, and palmitic long chain fatty acids as the nematocidal ingredients.

The range of claimed effective carbon chain length is summarized in TABLE 1.

TABLE 1
Reported effective chain lengths for nematocidal activity.

| | Minimum | Maximum | Range |
|---|---|---|---|
| Reference | C chain | C chain | (Max-min) |
| Tarjan and Cheo* | C4 | C18 | 15 |
| Sitaramaiah and Singh* | C1 | C4 | 4 |
| Malik and Jairajpuri* | C1 | C4 | 4 |
| U.S. Pat. No. 5,192,546 to | C7 | C20 | 14 |
| Abercrombie* | | | |
| U.S. Pat. No. 5,674,897 to | C9 | C12 | 4 |
| Kim et al.** | | | |
| U.S. Pat. No. 5,698,592 to | C8 | C14 | 7 |
| Kim et al.** | | | |
| U.S. Pat. No. 6,124,359 to | C8 | C14 | 7 |
| Feitelson et al.** | | | |
| U.S. Pat. No. 6,903,052 | C16 | C20 | 5 |
| Williams et al.** | | | |
| McElderry et al.* | C3 | C4 | 2 |

*= fatty acids tested
**= fatty acid derivatives

TABLE 1 shows there is considerable variation in the reported carbon chain length for nematocidal activity. This may be due to differences in test procedure, differences in nematode species, type of derivative, or fatty acid purity used in the testing. It is known that commercially available fatty acids vary in purity due to manufacturing process and source material. For example, a commercial oleic acid product, Emery 1202, contains approximately 76% oleic acid with the remainder being a mixture of other fatty acids.

A different perspective on optimal chain length is found in U.S. Pat. Nos. 6,306,415; 6,444,216; and 6,953,814 to Reifenrath. In these patents, Reifenrath shows that in contrast to killing insects, blends of fatty acids (C8:C9:C10 in a 1:1:1 ratio) can serve as repellents of pests such as flies and mosquitoes. The repellency is based on volatilization of fatty acids from treated surfaces (in these cases the skin of treated animals) and the combination extends the period of repellency because the different fatty acids have different rates of volatilization. The volatile fatty acid vapors can interfere with the normal sensory processes of insects. This work was extended by the US Centers for Disease Control and Prevention who found the C8:C9:C10 blend was insecticidal when six species of mosquitoes (all confirmed malarial vectors) were confined in a bottle assay with the volatile fatty acid blend (Dunford et al.). Differences were found among species in sensitivity. This showed fatty acid blends alone could be toxic to species other than nematodes without other insecticides, such as avermectins, in a treatment blend.

When used as a repellent, concerns about phytotoxicity are negated, as the fatty acids are applied to either inert surfaces (e.g., mosquito netting or walls), used in the vapor phase, or applied to animals (humans or cattle). However, none of the Reifenrath patents teach a soil application method for controlling agricultural pests, and all claim repellency, not toxicity, to pests.

In spite of the extensive research cited in the examples above, there is still no consensus about what constitutes a non-phytotoxic and effective nematicide based on fatty acids or even if such a use is possible. Also, there are no references found that teach direct soil application for nematocidal activity.

Fatty acids have been reported by several authors to control various fungal diseases, but the same limitation reported for nematicides exist, namely phytotoxicity. An early report of fungicidal activity from short chain carboxylic acids was by Hefting and Drury (U.S. Pat. No. 3,895,116) who found that mixtures of at least two short chain acids (selected from propionic, butyric, or isobutyric acids) were useful for preventing mold growth on stored grains and animal feedstuffs such as silage, hay, seed-meal, and high protein feedstuffs. In addition, antibacterial activity was observed. In this case phytotoxicity is not an issue as the substrate being treated is inert compared to plant foliage.

Frick and Burchill (U.S. Pat. No. 3,833,736) reported control of overwintering fungi on dormant plants by using blends of medium chain (C6-C18) fatty alcohols and esters, but not acids. In U.S. Pat. No. 3,931,413, they also show C6-C18 fatty acids also have essentially the same activity observed for the alcohols on overwintering fruit trees. However, selectivity (non-phytotoxicity) is only obtained on dormant or near dormant trees which are not actively growing. Thus, in this case, selectivity is obtained via a temporal avoidance of sensitive tissue and not inherently non-phytotoxic formulations of fatty acids.

Selected salts of fatty acids (preferably C8 to C12 chain length) were successfully used as foliar applied non-phytotoxic fungicides (U.S. Pat. No. 5,246,716) in contrast to reported phytotoxicity of sodium or potassium salts. The calcium, copper, iron, and zinc salts of C8-C12 fatty acids are fungitoxic without being phytotoxic in foliar sprays. With a given salt cation, efficacy varied according to acid chain length, with calcium octanoate being twice as effective as calcium hexanoate and up to 10 times more active than calcium butyrate. The formulation of these salts was critical for low phytotoxicity. The preferred formulation was a suspension concentrate, in which the fatty acid salts are suspended as an insoluble solid which is deposited on the plant leaf exterior and is not absorbed into the plant. Therefore the lack of phytotoxicity is due to the physical property of poor solubility of the fatty acid salt in the formulation. It is not known if these salts have inherently lower phytotoxicity potential if absorbed into leaf tissue.

U.S. Pat. No. 3,983,214 reports fatty acid derivatives as effective fungicides, based on sucrose esters of C8-C18 fatty acids. These compounds are also claimed to have anti-bacterial and anti-viral activity. No theory is presented why these esters are fungitoxic without phytotoxicity.

U.S. Pat. No. 5,342,630 reports combinations of potassium salts of oleic, stearic, and palmitic acids (C16-C18) and basic salts such as potassium bicarbonate and potassium carbonate. No phytotoxicity is reported, and these combinations are reported to be antagonistic to both fungi and insects. No teaching of shorter chain fatty acids is made. A related patent, U.S. Pat. No. 5,518,987, claims potassium fatty acid salts not as active ingredients but rather as formulants that act as spreader stickers when used in conjunction with other fungicidal active ingredients. This is a distinctly different application than when used as a fungicide active ingredient.

U.S. Pat. No. 5,366,995 teaches use of fatty acids and fatty acid salts as curative fungicides for foliar on plants. It specifically claims C9 to C18 fatty acids or the sodium, potassium, or isopropylamine salts of those FAs applied singly at a concentration of 0.1 to 1% to control fungal diseases on non-formant grape tissue. For broader use on crops other than grapes, it recommends C18 fatty acid and salts (again singly) at a concentration of 0.1 to 2%. Combinations of fatty acids or their salts are not claimed. A related patent U.S. Pat. No. 6,136,856 teaches combinations of fatty acids, and a series of fatty acid derivatives to control fungal diseases on fruits either before or after harvest with several methods of application including spraying, dipping, or inclusion of the fatty acids in post-harvest waxes applied to fruit. However, there are no claims for application to soil or any mention of soil fungal pathogens.

There are numerous literature references of fatty acids acting as anti-bacterial agents for bacteria that act as human or animal pathogens. For example Karabinos and Ferlin (1954) found that C9-C12 fatty acids controlled a number of bacteria in vitro, and this activity could be modified by the pH of the test solution. Kabara et al. (1972) found lauric acid to be the most active fatty acid against gram positive bacteria and that esters of fatty acids were much less active, with the exception of monoglycerides. Bergsson et al. (2002) reported medium chain fatty acids synergistically control Helicobacter pylori from the human stomach in combination with monoglycerides. Kim and Rhee (2013) found medium chain fatty acids combined with other, non-fatty organic acids controlled the notorious pathogen E. coli O157:H7. Hinton and Ingram (2011) found combinations of fatty acids and chelating agents acted as bactericides when used in poultry processing baths. U.S. Pat. No. 5,660,842 teaches administering monoglycerides of C8-C16 fatty acids or lauric acid alone as therapy for H. pylori infection in humans. U.S. Pat. No. 6,472,358 teaches the use of C5-C14 fatty acids as a component of anti-bacterial surface sterilizing solutions for use in settings such as food, drink, pharmaceutical, cosmetic, and similar processing industries. U.S. Pat. No. 7,109,241 teaches the use of heptanoic acid as the antibacterial agent in a teat treatment for dairy cows to prevent mastitis.

Reports of bactericidal activity against plant pathogens are far less numerous than for the other uses reported above. A commercial product formulation of copper octanoate is sold for control of certain bacterial diseases of vegetable crops (CAMELOT O Label, SePRO Corporation, Carmel, Ind.). Other claims for bacterial control from free fatty acid formulations have not been found in the literature.

### SUMMARY OF THE INVENTION

An objective of this patent is to provide both compositions and methods of using fatty acids in a way that overcome the above problems associated with fatty acids that allow for their successful use in agricultural systems. It is a further objective to provide both compositions and methods of using fatty acids that do not cause phytotoxicity to treated substrate plants. It is still a further objective to provide both compositions and methods of using fatty acids in an effective amount to treat or prevent infestations or infections of nematodes, fungi, oomycetes, and/or bacteria for a plant in need thereof.

### BRIEF DESCRIPTION OF THE DRAWINGS

Further advantages of the invention will become apparent by reference to the detailed description of preferred embodiments when considered in conjunction with the drawings:

FIG. 1 is a bar graph showing inhibition of Pythium aphanidermatum spore germination by C8, C9, C10. Zone of inhibition is shown in mm.

FIG. 2 is a bar graph showing mean zone of inhibition of V. dahliae and V. albo-atrum around discs saturated with three concentrations of C8, C9, C10 at 3 days post inoculation. Data presented are from 2 replicate experiments. Error bars represent the standard error of the mean. Bars for each pathogen with different letters are significantly different at α=0.05.

FIG. 3 is a bar graph showing mean zone of inhibition of Fusarium oxysporum fsp. radicis-lycopersici (FORL) around discs saturated with three concentrations of C8, C9, C10 at 2 days post inoculation. Error bars represent the standard error of the mean. Bars with different letters are significantly different at α=0.05.

FIG. 4 is a bar graph showing mean zone of inhibition of F. fujikoli around discs saturated with three concentrations of C8, C9, C10 (code named AP-8030 for trial purposes)at 2 days post inoculation. Error bars represent the standard error of the mean. Bars with different letters are significantly different at α=0.05.

FIG. 5 is a line graph showing the effect of C8, C9, C10 (code named AP-8030 for trial purposes) on yield of strawberry plants grown in soil infested with Macrophomina (charcoal rot disease).

### DETAILED DESCRIPTION OF THE INVENTION

This invention relates to the discovery that contrary to the oft repeated statement that fatty acids are too phytotoxic to use on non-dormant, actively growing plants, we have surprisingly discovered that proper selection of fatty acid compositions and their use in a novel method allows for control of plant pathogenic nematodes, fungi, oomycetes, and bacterial pathogens in the soil matrix the plants are growing in. This invention relates to compositions and methods to control nematodes, fungi, oomycetes, and bacteria in economically useful species including fruits, nuts, or other harvestable producing plants when they are grown in a cultural system that requires periodical replanting of the crop plant.

Fatty acids are a group of naturally occurring compounds that are commercially produced from triglycerides via splitting of the fatty acids from a glycerine backbone. Fatty acids (“FAs”) have a hydro-carbon chain and terminate in a carboxylic acid, with no other substitution. Naturally occurring fatty acids have an even number of carbons while odd number fatty acids are typically made via a synthetic pathway. Fatty acids with less than 6 carbons are called short chain, medium chain fatty acids have 6-12 carbons, long chain fatty acids have 13-21 carbons and very long chain fatty acids have 22 or more carbons. Both saturated and unsaturated (e.g., Stearic and Oleic acids respectively) fatty acids are observed in nature. Medium, long, and very long fatty acids are not soluble in water and to be useful for applications, these must either be converted into water soluble salts (known as soaps) or combined with solvents and/or surfactants to form an emulsifiable product.

Fatty acids have myriad biological roles in nature, especially as components of membranes and energy metabolism. Independent of these functions, other effects are observed. Of particular interest is the activity of fatty acids as pesticides. Fatty acids have several desirable traits as pesticides. First, there is very little toxicity to mammals and fish, and some fatty acids are designated as “Generally Regarded as Safe” by the US Food and Drug Administration for direct food consumption. This is not surprising considering they are derived from natural, edible oils. Second, because fatty acids are essential components of microbial metabolism, they are rapidly degraded in the environment and have very short half-lives. Aside from possible eye and skin irritation among pesticide handlers, there is very little short or long term safety or environmental hazard inherent in fatty acids.

The compositions described herein contain mixtures of one or more fatty acids formulated as emulsifiable concentrates. Special attention is given to the hard water compatibility of the compositions to avoid the formation of insoluble salts, such as calcium soaps, that will render the fatty acids inactive. We have found that proper selection of emulsifiers is critical for hard water compatibility of fatty acids.

Embodiments of fatty acids that exemplify the present invention include C10 fatty acid, C8:C10 fatty acids in about 1:1 blend ratios, and C8:C9:C10 in about 1:1:1 blend ratios. Some embodiments of the formulated blends of the present invention allow for effective doses of fatty acids to control plant pathogens to a plant (soil) in need thereof while simultaneously avoiding concentrations of specific fatty acids that are phytotoxic. For example, it has been widely reported that the C9 fatty acid, nonanoic acid, its salts, and its esters are highly phytotoxic to a wide variety of plants, and this property is used to create a contact herbicide using a 5% solution of ammonium salt of nonanoic acid (AXXE® herbicide by Biosafe Corp.). It has also been reported to be a highly active nematocide in laboratory studies. Therefore, it is highly desirable to use nonanoic acid to control pathogens, but it must be used at concentrations, in formulations, and in methods that do not result in phytotoxicity. We have surprisingly found that C9 FA blended with other pesticidal fatty acids that are less phytotoxic or non-phytotoxic allows for a formulation blend having pesticidal activity without causing phytotoxicity.

The formulation of compositions into stable forms that can be conveniently used by the farmer is a critical step. Aside from limited information provided by Tarjan and Cheo, there is very little taught about formulations in the scientific or patent literature. For broad applicability, fatty acids must form stable emulsions across a wide variety of spray water quality, ranging from 25 to 2000 ppm (or higher) of dissolved hard water ions such as calcium, magnesium, iron, aluminum, and other less abundant ions. Emulsion stability in hard water is especially important under certain conditions. For example, when drought has prevented normal supplies of irrigation water, growers often resort to ground water for irrigation, which can have very high dissolved hard water ions. The operational problem with fatty acids in hard water is the tendency of fatty acids to react with ions such as calcium and precipitate out of solution as a soap, thus lessening their biological activity. A common example of this is the “bathtub ring” which is soaps of fatty acids that precipitate from solutions with high water hardness. The “soap scum” is the accumulated fatty acid soaps.

Formulation of the fatty acids to allow for performance in a wide range of water hardness is not a topic that has been addressed either in the scientific literature or in the patent literature. In this disclosure we provide FA and surfactant compositions that allow for stable emulsions upon dilution in up to or over 2000 ppm hard water. This allows for use of these FA compositions across a wide variety of water hardness levels and geographical areas without loss of biological activity.

Of the examples discussed in the background, none teach the following: 1) use of fatty acid combinations to control nematodes, fungi, oomycetes, and bacteria, 2) selection of components of fatty acid blends that can control nematodes, fungi, oomycetes, and bacteria without causing phytotoxicity, 3) formulation of fatty acids to tolerate hard water, or 4) a method for applications of fatty acid blends directly to soil and foliage at concentrations that do not cause phytotoxicity.

In summary, improved, more environmentally and agriculturally acceptable formulations for control of pathogenic nematodes, fungi, oomycetes, and bacteria are described.

The phytotoxicity of fatty acids has been a major constraint on their general use in agricultural applications, and the mitigation of these undesirable effects while preserving pesticidal activity has been an active area of research.

Fatty acids are known to inhibit or kill a wide variety of plant pathogens including nematodes, fungi, and bacteria. However, the reported effects in the literature are often contradictory and confusing. One feature consistently reported, however, is the phytotoxicity of fatty acids to growing plants or plant tissue. Surprisingly, we have discovered compositions of fatty acids that are both non-phytotoxic to the desired target plants at the effective use rate (effective amount) and still efficacious as a biopesticide (pesticidal activity to treat or prevent).

Surprisingly, we have found that plant pathogenic nematodes, fungi, oomycetes, and bacteria can be controlled by soil applications of formulated combinations of fatty acids without damage to the crop plants themselves, even during active growth of the crop plants. This is in direct contrast to numerous scientific publications and patents which teach this is difficult or impossible to do. Perhaps most surprising, the fatty acid combinations of the present invention, including exemplary embodiments described herein, can include fatty acids that are specifically claimed or have been claimed to be highly phytotoxic, such as nonanoic acid (also known as pelargonic acid) which is sold commercially as a herbicide. Thus, we have found that the selection of fatty acids in the blends, concentration of each fatty acid component, formulation, and application method all contribute to the efficacious control of described pests without causing phytotoxicity.

### SELECTION OF FATTY ACIDS

Biological activity (pesticidal activity) has been reported for FAs with carbon chain lengths of C4 to C18 and higher. All combinations of two or more FAs with carbon chain lengths of C4 to C18 and higher can be practiced according to compositions of this invention. Preferred chain lengths of FAs in compositions of the invention are the medium chain lengths of C6 to C12, and more preferred are chain lengths of C8 to C10.

Concentrations of fatty acids in a pesticidal product are limited by the need to have an added emulsifier to the formulation. The preferred concentration range of the fatty acids in the compositions of the present inventions are from 0.1 to 90% total fatty acid, and more preferably with a maximum amount of 50% of total fatty acid, and most preferred with approximately 30% of total fatty acid.

Ratios of the fatty acids in a blend can be from 0.1 to 99.9% for a two way combination with a preferred amount of approximately 50% of each. In a three way blend the ratio can be from A:B:C, where A, B, and C are greater than 0 and A+B+C=100% of the total fatty acids. Preferred ratios of three way combinations are approximately 1:1:1. In combination of 4 or more fatty acids, the ratios must meet the following formula A+B+C+D+. . . X, where A, B, C, D, and X are greater than 0 and A+B+C+D+. . . X=100% of total fatty acids.

### EXAMPLES

Compositions of free fatty acids are insoluble in water and must be formulated using standard formulation methods to emulsify the free fatty acids. The following illustrative examples of different formulations (emulsifiable concentrates or EC) and the resulting test show some formulation principles of the present invention of maximizing fatty acid efficacy and crop safety.

TABLE 2

| | Example 1 Formulations | | | | | | |
|---|---|---|---|---|---|---|---|
| | 1(a) | 1(b) | 1(c) | 1(d) | 1(e) | 1(f) | 1(g) |
| Octanoic acid | 30 | — | — | 15 | 10 | — | 10 |
| Nonanoic acid | — | 30 | — | — | 10 | — | 10 |
| Decanoic acid | — | — | 30 | 15 | 10 | — | 10 |
| Tall oil fatty acid | — | — | — | — | — | 30 | — |
| Paraffinic oil | 40 | 40 | 40 | 40 | 53 | 40 | 42 |
| Sorbitan trioleate | 6 | 6 | 6 | 6 | 6 | 6 | 6 |
| Ethoxylated Sorbitan | 20 | 20 | 20 | 20 | 7.5 | 20 | 20 |
| Monooleate 20 POE | | | | | | | |
| CaDDBS | 2 | 2 | 2 | 2 | 2 | 2 | — |
| Water (to 100%) | 2 | 2 | 2 | 2 | 1.5 | 2 | 2 |

TABLE 3

Example 2

| | 2(a) | 2(b) |
|---|---|---|
| Octanoic acid | — | 5 |
| Nonanoic acid | — | 5 |
| Decanoic acid | — | 5 |
| Soybean oil ethoxylate | 53 | 45 |
| Reverse block polymer 25R2 | 10 | 8.5 |
| Block polymer P104 | 7 | 6 |
| Castor oil ethoxylate | 9.4 | 8 |
| Alkylpolyglucoside | 17.7 | 15 |
| Water (to 100%) | 2.9 | 2.5 |

The compositions of Example 1 were tested against infective juvenile M. incognita in a petri dish assay (TABLE 4). 50 infective J2 larvae were added to dishes containing 0.01% and 0.1% of formulated C8, C9, C10, and C8+C10 fatty acid ECs. After 24 hours, larvae were touched with a hair brush. Nematodes were considered dead if they did not respond to touch.

TABLE 4
Effect of formulated fatty acid blends on
nematode survival in petri dishes.

| | Carbon | 0.1% | 0.01% |
|---|---|---|---|
| Treatment | chain | % survival | % survival |
| Example 1(a) | 8 | 0 | 0 |
| Example 1(b) | 9 | 0 | 27 |
| Example 1(c) | 10 | 0 | 50 |
| Example 1(d) | 8 + 10 | 0 | 70 |
| Example 1(f) | TOFA | 90 | 90 |

All fatty acid ECs, except tall oil fatty acid, were toxic to M. incognita juveniles in vitro at 0.1%, and the C8 fatty acid formulation was more toxic than the others at 0.01%. Interestingly, the C10 fatty acid was less toxic than the others so that the blend of C10 and C8 (each at half the rate as the stand alone) resulted in significant reduction in toxicity. This demonstrates that not all fatty acids are equally toxic to nematodes, and combinations of fatty acids can give differential toxicity compared to single fatty acids alone. The fatty acid makeup of tall oil fatty acid is approximately 90% or higher fatty acids consisting of palmitic (C16), oleic (C18:1), and linoleic (C18:2) fatty acids. It is apparent that this source of fatty acids has very low, if any, activity against M. incognita juveniles.

From the results in TABLE 4, Example 1(a) with the C8 fatty acid was the most toxic fatty acid to M. incognita juveniles. Continued dilution of example 1(a) is shown in TABLE 5.

TABLE 5
Percent survival of M. incognita juveniles
in petri dish test with example 1(a).

| | Concentration % | | | | |
|---|---|---|---|---|---|
| | 0 | 0.05 | 0.025 | 0.01 | 0.005 |
| Formulation | 100 | — | — | — | — |
| blank | | | | | |
| Example | — | 0 | 0 | 0 | 0 |
| 1(a) | | | | | |

The formulation of C8 fatty acid is very toxic to juvenile M. incognita larvae in vitro at very low levels.

The alternate Example 2 EC formulations from 2(a) and 2(b) were compared to Example 1(e) in other tests. The results are shown in TABLE 6.

TABLE 6
Effect of different formulations of fatty acids on survival
of juvenile M. incognita in petri dish test.

| Treatment | % survival |
|---|---|
| Water only | 88 |
| Example 1(e) 0.1% | 1 |
| Example 2(b) 0.1% | 5 |
| Example 2(a) 0.1% | 81 |

This result indicates that alternate EC formulation designs (e.g., example 2(b)) can be efficacious in a petri dish test compared to Example 1(e) which has a different emulsifier system. Therefore, efficacy is obtained with at least two formulation examples in an in vitro system using distilled water.

A more complex test system uses petri dishes filled with acid washed sand. This system is more representative of a field application. TABLE 7 shows the results with juvenile M. incognita larvae.

TABLE 7
Effect of different formulations on juvenile M incognita survival in
sand filled petri dishes (24 hour after application).

| Treatment | % survival |
|---|---|
| Water control | 98 |
| Example 1(a) 1% (C8) | 6 |
| Example 1(b) 1% (C9) | 4 |
| Example 1(c) 1% (C10) | 3 |
| Example 1(d) 1% (C8 + C10) | 3 |
| Example 1(f) 1% (Tall Oil Fatty Acids) | 95 |

The results are very similar to the water only petri dish tests, except at a higher dose rate in the sand. The medium chain free fatty acids are toxic to the nematodes, but the longer chain tall oil fatty acids formulation is not.

As shown in the literature review above and the general description, the phytotoxicity of fatty acids has been a major concern for developing fatty acids as effective nematocides. The response of tomato seedlings was used to gauge the phytotoxicity potential of the fatty acid EC's in the examples.

Tomato seedlings were started in 50 mL centrifuge tubes filled with sand. When the plants reached approximately 10 cm height, 1 mL of test solutions were applied to the sand near the base of the plant. Plants were assessed for phytotoxicity at 4 days after application. Phytotoxicity could be expressed in several ways including loss of color (from green to yellow), wilting, leaf burning (necrotic tissue), or seedling death. Any symptom observed on any plant was counted as a phytotoxic response. TABLE 8 shows the percent of plants with any phytotoxicity symptoms at 4 days exposure to the fatty acid treatments.

TABLE 8
Phytotoxicity of fatty acid solutions to
tomato seedlings at 4 days after treatment.

| | % of plants exhibiting |
|---|---|
| Treatment | phytotoxic symptoms |
| Water control | 0 |
| 1(a) 1% - C8 | 0 |
| 1(a) 0.5% - C8 | 20 |
| 1(b) 1% - C9 | 88 |
| 1(b) 0.5% - C9 | 0 |
| 1(c) 1% - C10 | 0 |
| 1(c) 0.5% - C10 | 0 |
| 1(d) 1% - C8 + C10 | 63 |
| 1(d) 0.5% - C8 + C10 | 0 |
| 1(f) 1% - Tall Oil Fatty Acid | 0 |

These results clearly indicate that applied fatty acids at high enough concentrations (e.g., 1% EC containing 30% total fatty acids) can cause severe phytoxicity, particularly for the known phytotoxic C9 pelargonic acid. However, when the concentration is reduced the sensitive tomato seedlings can tolerate the applied fatty acids. Thus plant selectivity can be obtained at concentrations of fatty acids that are toxic to nematodes. It is clear that the effect of fatty acids is mediated by the matrix the nematodes are living in. When exposed to fatty acids in sand, higher concentrations are required than in water alone. The soil medium has an effect on the toxicity of the fatty acids, which could be due to availability of the active ingredient to plant pathogens in solid medium.

To consider this effect, a field trial was conducted in an almond orchard infected with the lesion nematode, Pratylenchus sp. Before treatments were applied, 10 soil cores were taken underneath each of five trees for nematode counts. The 10 samples were homogenized and 300 ml of soil were removed for nematode extraction. Nematodes were extracted from soil using Baerman funnels. After initial sampling, the five trees were treated with one gallon of a 2% solution of example 1(g) sprayed in a 6 foot diameter circle around the base of each tree. After treatment, 3 acre-inches of water were applied via a microspray irrigation system to wash the product into the soil. One week after treatment, an additional 10 cores were taken from underneath each of the treated trees. The 10 samples were homogenized and 300 ml of soil were removed for nematode extraction. Nematodes were extracted from soil using Baerman funnels. The only nematode species that was found consistently in all samples was the lesion nematode, Pratylenchus sp. TABLE 9 shows the effect of the 2% spray on Pratylenchus counts. Data is expressed as % change from initial (pre-treatment) counts after 7 days of treatment (post treatment).

TABLE 9
Effect of fatty acid treatment on nematode counts seven days after
treatment with Example 1(g) EC formulation.

| Treatment | % change from PRE treatment counts |
|---|---|
| Untreated | −38% |
| 1 gallon/tree 2% 1(g) | −84% |

This result indicates that fatty acid treatment can depress Pratylenchus sp. numbers in a field environment. It is important to note that field nematode trials can be difficult to perform as a result of natural variations in nematode populations due to environmental conditions and normal population dynamics, as well as sufficiently robust sampling to detect true differences.

A second study examined the effect of fatty acids on nematodes in a confined environment, namely a drum filled with field soil and then placed into the ground to soil level. The “barrel study” was artificially infested with root-knot and ring nematodes. Following treatment with C8, C9, C10 (10% of each fatty acid for a total of 30% fatty acid loading) at 7.5, 15, and 30 gallons/A and a standard of TELONE II at 17 gallons/A (drench treatment) nematode counts were taken at the end of the growing season (treatments applied June 6^{th}, counts taken on December 7^{th}). For both nematode species, the untreated plots very high nematode counts. For root-knot nematodes, all C8, C9, C10 (code named AP-8030 for trial purposes) treatments had lower counts than the TELONE II treatment. Similar trends held for ring nematodes. Results for both nematode species are shown in TABLE 10.

TABLE 10
Impact of drench treatments of C8, C9, C10 on end of season
nematode counts in infested soil contained in barrels

Count per
100 cc soil
sample

| Treatment | rate | Root knot | Ring |
|---|---|---|---|
| Untreated | — | 1320 | 1000 |
| TELONE II std | 17 gal/A | 760 | 560 |
| C8910 | 7.5 gal/A | 300 | 180 |
| C8910 | 15 gal/A | 240 | 460 |
| C8910 | 30 gal/A | 280 | 540 |

A third study known as a “bag study” was conducted. In this method, soil in a breathable bag is inoculated with a known amount of nematodes (in this case root-knot), placed in soil plots, and treated via irrigation with 7.5, 10, 30, and 45 gallons/A of C8, C9, C10 (code named AP-8030 for trial purposes). Nematode infested bags were recovered at 14 and 21 day after treatment and counted. Pic-Clor 60 was used as a commercial standard. At 14 days after treatment C8, C9, C10 at 45 gallons/A and Pic-Clor 60, both showed statistically significant reductions in nematode counts with 44% control obtained by AP-8030 at 45 gpa and 65% control with Pic-Clor 60. At 21 DAT, AP-8030 at 30 gallons/A gave 50% reduction, the greatest observed for any treatment. Results are shown in TABLE 11.

TABLE 11
Effect of C8, C9, C10 on percent control of root-knot nematodes
contained in breathable bags buried in soil prior to irrigation treatment
with C8, C9, C10. (results at 14 and 21 days after treatment - DAT)

% control
vs untreated

| Treatment | rate | 14 DAT | 21 DAT |
|---|---|---|---|
| Untreated | — | 0 | 0 |
| Pic-Clor 60 std | 32 gal/A | 64.8% | 26% |
| C8,9,10 | 7.5 gal/A | 11.7% | 12.5% |
| C8,9,10 | 15 gal/A | 31.8% | 19.2% |
| C8,9,10 | 30 gal/A | 17.2% | 50.2% |
| C8,9,10 | 45 gal/A | 44.9% | 26.3% |

Studies analogous to the nematode trials were conducted with pathogenic fungi.

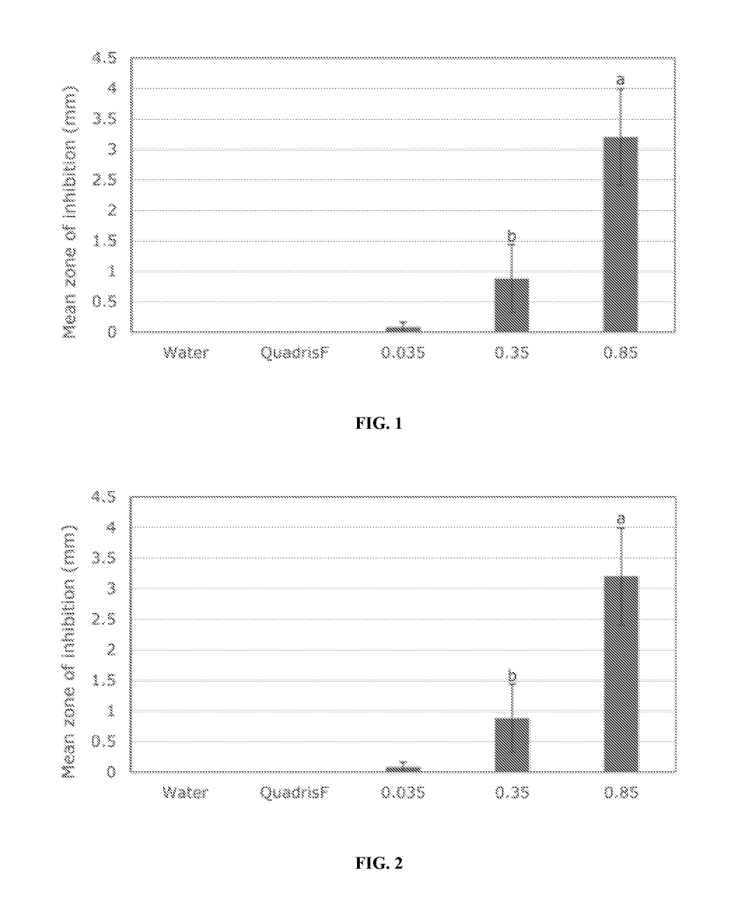

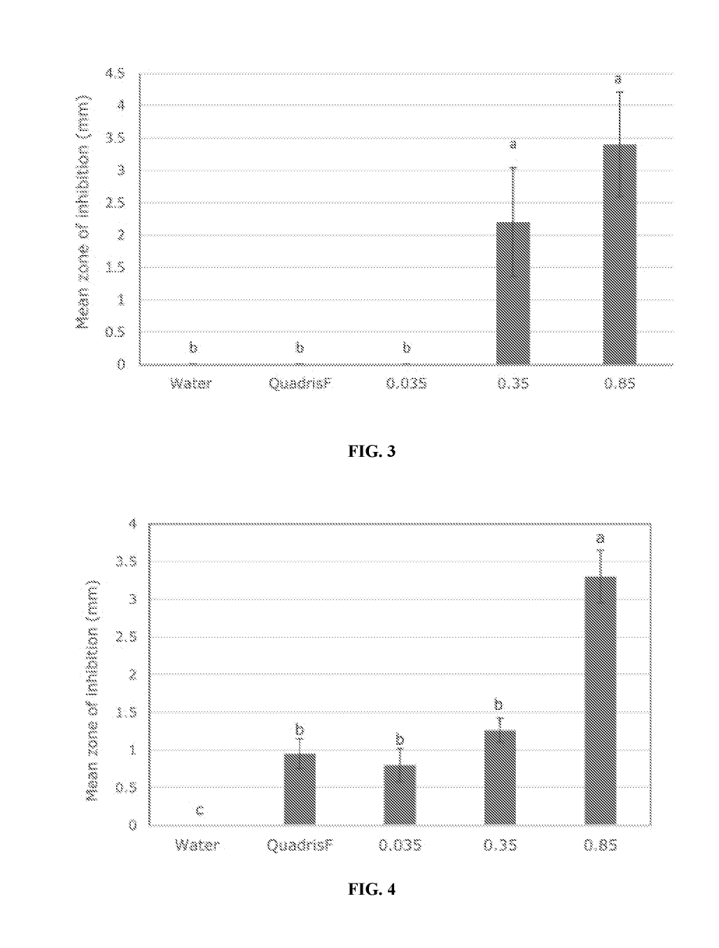

An in vitro laboratory study was conducted at the Vineland Research Center (Guelph, Ontario) on the efficacy of C8, C9, C10 against five fungal pathogens (two Verticillium spp, one Pythium sp, and two Fusarium spp.). Two growth stages of fungal growth were examined: spore germination and fungal mycelia growth (“vegetative growth”). C8, C9, C10 did not inhibit mycelium stage of any of the tested species at any tested concentration (0.035%, 0.35% and 0.85%). However, in the spore germination test, Pythium was inhibited at 0.85% (FIG. 1), both Verticillium species were inhibited at 0.35 and 0.85% (FIG. 2), one Fusarium sp was inhibited at 0.35 and 0.85% (FIG. 3), while the second Fusarium sp was partially inhibited down to 0.035% (FIG. 4).

The bag study for nematodes described above was also infested with a Fusarium oxysporum inoculum. Pic-Clor 60 is the standard, and it provided 100% control. The best C8, C9, C10 (code named AP-8030 for trial purposes) treatment was with 15 gallons/A which provided 45% control. While this result gave trending results, it is not significant.

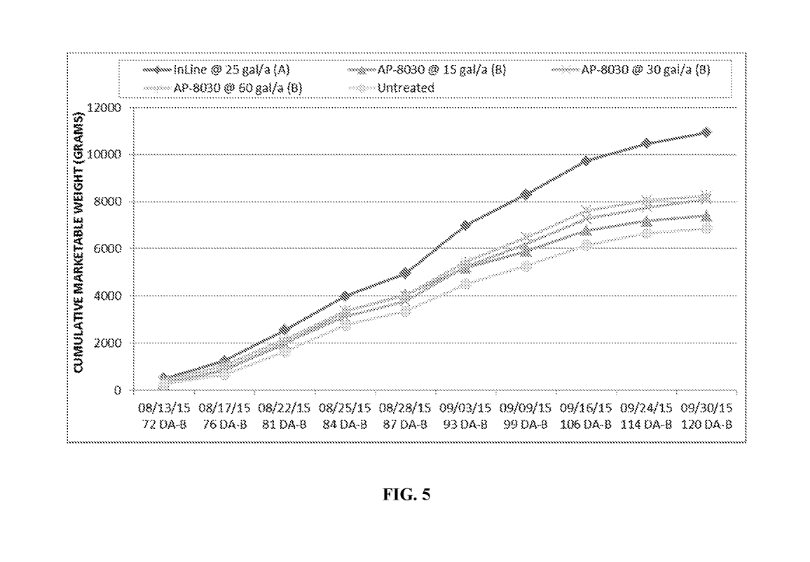

In a further study, strawberries were grown in a field infested with “charcoal rot” caused by Macrophomina phaseolina, an important pest of strawberries. Single treatments with 15, 30, and 60 gallons/A of C8, C9, C10 prior to planting promoted plant health and crop yield. Multiple pickings of berries over a 2 month period revealed that C8, C9, C10 gave equivalent yield to commercial standard “IN LINE” until about ⅓ through harvesting, then the C8, C9, C10 effect “wore off,” probably due to biodegradation. C8, C9, C10 gave improved yields over untreated, but ultimately the IN LINE performed best (FIG. 5). It is hypothesized that the C8, C9, C10 biodegrades and loses control over time. It is hypothesized that repeated applications of lower doses may overcome this.

Phytotoxicity

The use of C8, C9, C10 as formulated (e.g., AP-8030 experimental formulation) as an EC with 10% of each fatty acid shows a lack of phytotoxicity when either applied as a single application before transplanting (for vegetables, for example) or through irrigation to already established plants. As shown in TABLE 12, drench applications were applied to 3 year old almond trees had no phytotoxic effect at 28 days after treatment.

TABLE 12
Effect of C8, C9, C10 on growth of 3 year old almond trees 28 days
after application.

| Treatment | rate | phytotoxicity rating |
|---|---|---|
| Untreated | — | 0 |
| C8,9,10 | 15 gallons/A | 0 |
| C8,9,10 | 30 gallons/A | 0 |
| C8,9,10 | 60 gallons/A | 0 |

Similar lack of phytotoxicity was noted on field grown Pinot Gris grapes (transplanted) with treatments applied via irrigation system. Ratings were taken at 21, 49, and 125 days after application (See TABLE 13)

TABLE 13
Phytotoxic effect of C8, C9, C10 applied via irrigation lines on
transplanted Pinot Gris seedlings at 21, 49, and 125 days after
treatment (% damage).

| | | Days after | | |
|---|---|---|---|---|
| | | treatment | | |
| Treatment | rate | 21 | 49 | 125 |
| Untreated | — | 0 | 0 | 0 |
| C8,9,10 | 15 gal/A | 0 | 0 | 0 |
| C8,9,10 | 30 gal/A | 0 | 0 | 0 |
| C8,9,10 | 60 gal/A | 2.5 | 0 | 0 |
| C8,9,10 | 120 gal/A | 0 | 0 | 0 |

In a further study, C8, C9, C10 was applied to soil prior to planting romaine lettuce followed by two irrigation applications. Phytotoxicity was measured at 20 days after the second irrigated application. Results are shown in TABLE 14.

TABLE 14
Phytotoxicity of C8, C9, C10 after three applications to field grown
romaine lettuce (20 days after last application - rate
equals total product applied).

| Treatment | rate | phytotoxicity rating |
|---|---|---|
| Untreated | — | 0 |
| C8,9,10 | 7.5 gal/A | 0 |
| C8,9,10 | 15 gal/A | 0 |
| C8,9,10 | 30 gal/A | 0 |
| Commercial standard | 7 oz/A | 0 |

These results show that under a variety of treatment regimens and with different species, that the formulated version of C8, C9, C10 disclosed herein shows unexpectedly safe crop safety with little or no phytotoxicity. This is in direct contrast to prior reports of fatty acids causing phytotoxicity when applied to crops. The inherent safety resulting from the proper selection of fatty acids, formulation, and method of application is unexpected after results previously reported in the literature.

Formulations of fatty acids present the problem of formation of fatty acid soaps in hard water. This is caused by formation of calcium and magnesium salts of fatty acids which are generally insoluble. Therefore, a formulation must be adjusted to give resistance to soap formation by proper selection of emulsifiers. TABLE 15 shows the influence of emulsifier selection on the formation of soaps in hard water. The water chosen is from a groundwater well sample from the Central Valley of California. Water hardness is in excess of 2000 ppm.

TABLE 15
Effect of hard water on stability of fatty acid formulations.

| | | Results | |
|---|---|---|---|
| | | in ≧2000 ppm | |
| Formulation | Emulsifiers | hardness water | |
| Example 2(b) | Reverse block polymer | 10 | Heavy soap |
| | Block polymer | 7 | precipitate |
| | Castor oil ethoxylate | 9.4 | |
| Example 1(e) | Sorbitan trioleate | 6 | Weak emulsion, |
| | Sorbitan monooleate(POE20) | 7.5 | oil separation in |
| | CaDDBS | 2 | 1 hour |
| Example 1(g) | Sorbitan trioleate | 6 | Emulsion stable |
| | Sorbitan monooleate(POE20) | 20 | overnight |

The ability to form a stable emulsion in hard water is critical to keeping the free fatty acids from forming inactive salts and losing efficacy against nematodes. While any emulsion is likely to be active in a laboratory test instability in field conditions is not desirable for an effective control agent. An illustration of this is example 2(b) shows excellent activity in laboratory tests (TABLE 6), yet the fatty acids rapidly form soaps and precipitate out of the spray solution when mixed in hard water (TABLE 15). An examination of the emulsifier systems in TABLE 15 shows that having sufficient quantities of a high HLB (HLB=Hydrophile:Lipophile Balance) surfactant is necessary for effective formulations of fatty acid nematocides.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

1. A composition for the control plant parasitic nematodes, fungi and bacteria consisting of a) mixture of one or more fatty acids and b) an emulsifying agent and, optionally c) a solvent, with d) other optional formulation auxiliaries such as defoamers, preservatives, and wetting agents to produce a non-phytotoxic combination.

2. The composition of claim 1, where the fatty acids are from C6-C22.

3. The composition of claim 1, where the fatty acids are from C8-C16.

4. The composition of claim 1, where the fatty acids are from C8-C12.

5. The composition of claim 1, where the emulsifying agent is selected from the group of sorbitan esters, sorbitan ester ethoxylates, nonylphenolethoxylates, castor oil ethoxylates, salts of dodecylbenzene sulfonic acid, where the HLB of the chosen emulsifiers is greater than 12 and preferably greater than 14.

6. The composition of claim 1, where the solvent is any agriculturally acceptable solvent that is approved for use in pesticide formulations by the United States Environmental Protection Agency.

7. The composition of claim 1 where the solvent is a paraffinic oil, a fatty acid methyl ester, an aromatic petroleum distillate, substituted fatty acid amide or a mixture of these.

8. The composition of claim 1 where the total fatty acid content is from 0.1 to 90% of the composition.

9. The composition of claim 1 where the total fatty acid content is more preferably from 5 to 50%.

10. The composition of claim 1 where the total fatty acid content is most preferably from 15 to 30% total fatty acid.

11. A method of applying the composition of claim 1 by applying undiluted composition or composition diluted to form a water emulsion to the target soil.

12. The method of claim 11, where the application is made by spraying directly on the target soil followed by irrigation to incorporate the product into the soil.

13. The method of claim 11, where the application is made on the soil via injecting the composition into an overhead irrigation system.

14. The method of claim 11, where the application is made via injecting the composition into a drip irrigation system.

15. The method of claim 11, where the treatment is applied to soil prior to planting trees, vines, bushes, seeds or transplants.

16. The method of claim 11 where the treatment is applied to soil with already established plants.

17. A composition where a dry formulation is produced by reacting a fatty acid or a fatty acid mixture with urea to produce a clathrate.

18. The composition of claim 14, where the fatty acids are from C6-C22.

19. The composition of claim 14, where the fatty acids are from C8-C16.

20. The composition of claim 14, where the fatty acids are from C8-C12.

21. A method where the composition of claim 17 where the composition is applied to soil followed by irrigation.

22. The method of claim 21 where the irrigation is via overhead irrigation, drip irrigation or flood irrigation.

23. A composition where a dry formulation is produced by blending a fatty acid or a fatty acid mixture on a dry carrier such as clay, organic material such as corn cob grits or cellulose based granules.

24. The composition of claim 18, where the fatty acids are from C6-C22.

25. The composition of claim 18, where the fatty acids are from C8-C16.

26. The composition of claim 18, where the fatty acids are from C8-C12.

27. A method where the composition of claim 23 where the composition is applied to soil followed by irrigation.

28. The method of claim 23 where the irrigation is via overhead irrigation, drip irrigation or flood irrigation.

29. A method where the composition of claim 1 is combined with other nematocidal, fungicidal, or bactericidal agents.

30. A method where the composition of claim 17 is combined with other nematocidal, fungicidal, or bactericidal agents.

31. A method where the composition of claim 23 is combined with other nematocidal, fungicidal, or bactericidal agents.
